(19) United States
(12) Patent Application Publication
(10) Pub. No.: US 2005/0186535 A1
(43) Pub. Date: Aug. 25, 2005

(54) Rubber dam frame

(76) Inventors: Dan J. Bills, Salt Lake City, UT (US); Carlos G. Puente, Santa Fe (AR); Silvio Nava, Buenos Aires (AR)

Correspondence Address: Rick D. Nydegger;WORKMAN NYDEGGER, 1000 Eagle Gate Tower, 60 East South Temple, Salt Lake City, UT, 84111, US

(21) Appl. No.: 10/786,214

(22) Filed: Feb. 25, 2004

(51) Int. Cl. A61C 5/14

(52) U.S. Cl. 433/136

(57) ABSTRACT

A rubber dam frame may be used to isolate a tooth or teeth during a dental procedure. The rubber dam frame includes a bendable support member. The bendable support member allows the dental practitioner to adjust the device to be more comfortable for the patient. In addition, the bendable support member and dam may be bent out of the way to allow the dental practitioner to have access to a portion of the patient's mouth to take an x-ray or for any other procedure. The frame includes barbs for holding a rubber sheet. The support member may be formed of aluminum or another malleable metal material. It may be anodized or otherwise surface treated.

### BACKGROUND OF THE INVENTION

1. The Field of the Invention

The present invention relates to the use of rubber dams in dentistry, and more particularly to a rubber dam frame for supporting a rubber dam in place while performing a dental procedure.

2. The Relevant Technology

While performing some dental procedures, it is desirable to isolate the tooth or teeth to be treated while protecting surrounding soft tissues. A rubber dam generally includes a thin rubber sheet stretched over a frame which is held in place over a patient's mouth. To work on a particular tooth or teeth, a hole is formed in the rubber dam and the dam is pushed down over the tooth or teeth. A clamp is used to hold the dam in place by clamping the rubber sheet to the patient's tooth. The rubber dam isolates the tooth to prevent damage to surrounding soft tissues, and also prevents the patient from swallowing or aspirating foreign objects or fluids that may otherwise accidentally enter the patient's mouth.

Often it is desirable to take x-rays or to otherwise examine the patient's mouth, which can be difficult or impossible with a rubber dam installed. While the rubber dam might possibly obscure the field of view, this is particularly true in the case of metal rubber dam frames, which must be removed if located anywhere between the x-ray machine and the tooth being x-rayed. These difficulties can cause frustration to the dental practitioner and result in unnecessary waste and delay.

### BRIEF SUMMARY OF THE INVENTION

The present invention is directed to a rubber dam frame that is bendable. Because the frame is bendable, it allows the rubber dam and frame to be bent so as to allow the dental practitioner to have access to the patient's mouth for taking x-rays or for performing other procedures. This allows a dental practitioner to access the patient's mouth for x-rays without having to completely remove the rubber dam and frame.

The rubber dam frame comprises a thin, metal, bendable support member having an inner edge and an outer edge. The support member is sufficiently bendable so as to allow a dental practitioner to bend a desired portion of the support member away from a patient's mouth so as to allow substantially unimpeded access to a desired area of the patient's mouth for performing x-rays or other procedures.

The rubber dam frame includes a plurality of barbs for retaining a rubber sheet. According to one embodiment, the barbs may be formed on the outer edge of the support member. According to another embodiment they may be formed by a plurality of recesses within the support member, between the inner and outer edges.

The support member of the rubber dam frame may be of various shapes, including closed shapes, such as circular or oval, or open shapes, such as three sides of a rectangle.

The support member may be formed of any sufficiently bendable material that substantially maintains its configuration when bent. In other words, the frame is not resilient. It does not “bounce back” to its original configuration once the deformation force is removed. One preferred material is aluminum. Aluminum sheet having a thickness of between about 0.005 and about 0.25 inch is preferred, between about 0.015 and about 0.062 is more preferred, and between about 0.02 and about 0.04 is most preferred.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIGS. 1A-1E are top views of various exemplary profiles for rubber dam frames;

FIG. 2 is a perspective view of an exemplary rubber dam kit comprising a rubber dam and frame;

FIG. 3 is a perspective view of an exemplary rubber dam system positioned over a patient's mouth in order to isolate a tooth while performing a dental procedure;

FIG. 4 is a perspective view of the rubber dam kit of FIG. 3 with the rubber dam bent so as to allow access to the patient's mouth for taking x-rays or performing other procedures.

### DETAILED DESCRIPTION OF THE PREFERRED EMBODIMENTS

I. Introduction

A detailed description of the invention will now be provided with specific reference to figures illustrating preferred embodiments of the invention. It will be appreciated that like structures will be provided with like reference designations.

The rubber dam kit of the present invention provides isolation of a tooth or area of the mouth to be worked on during a dental procedure. The rubber dam kit includes a rubber dam frame and a rubber sheet which can be assembled into a rubber dam system during use. The rubber dam frame is comprised of a thin, metal, bendable support member having an inner edge and an outer edge. The support member is sufficiently bendable so that a dental practitioner may bend a desired portion of the support member away from a patient's mouth so as to allow substantially unimpeded access to a desired area of the patient's mouth for performing x-rays or other procedures.

II. Exemplary Rubber Dam Frame

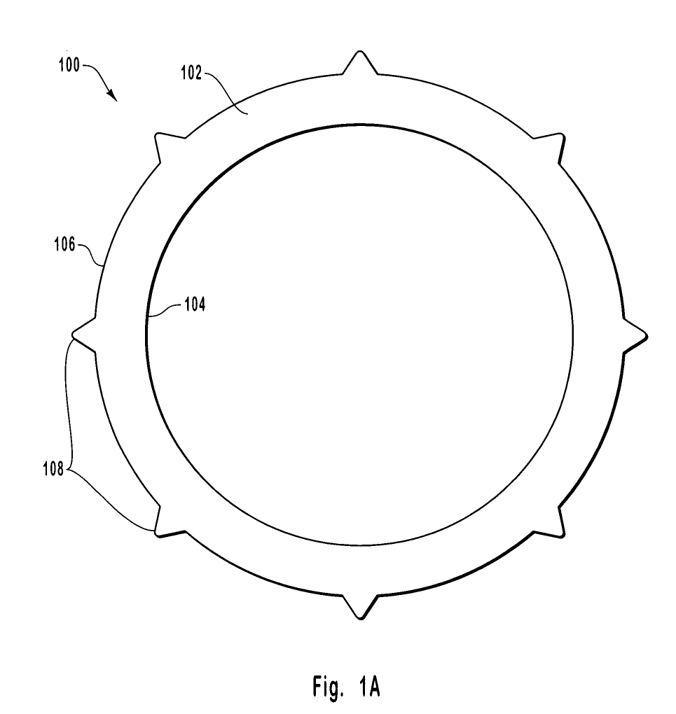

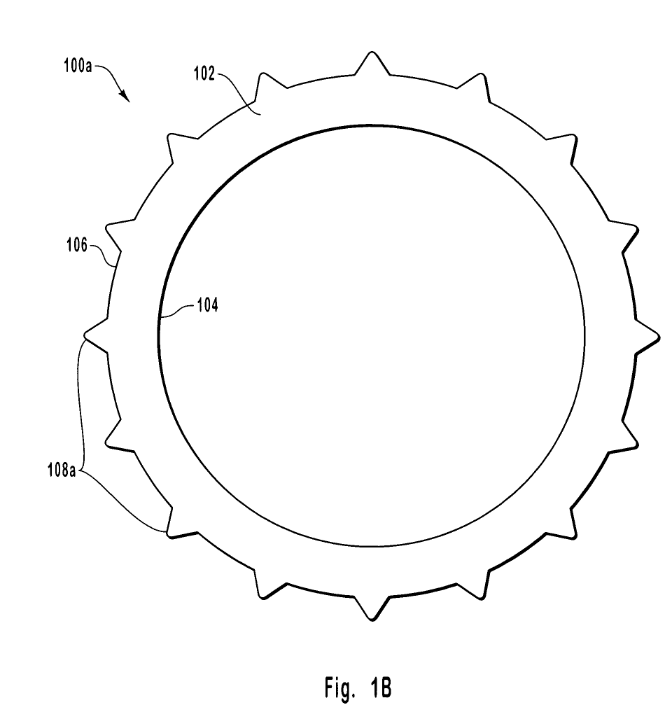

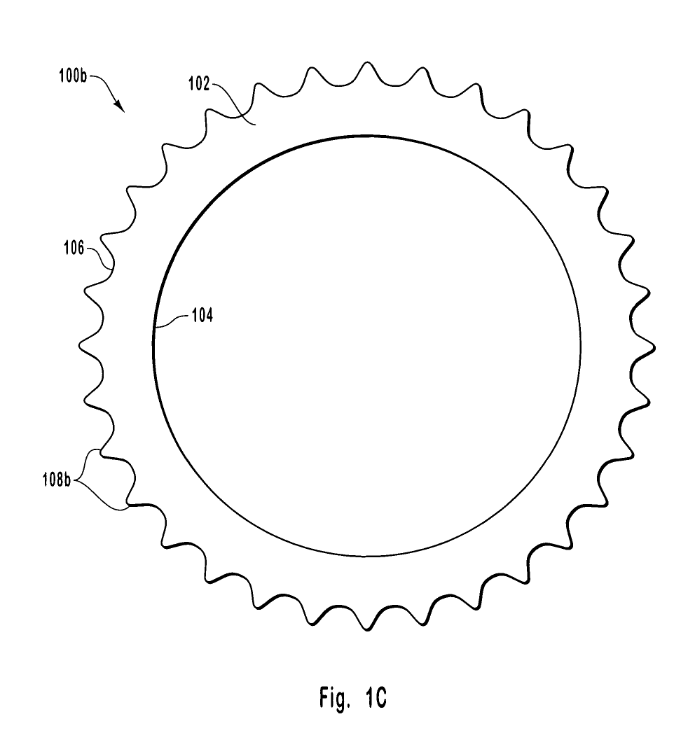

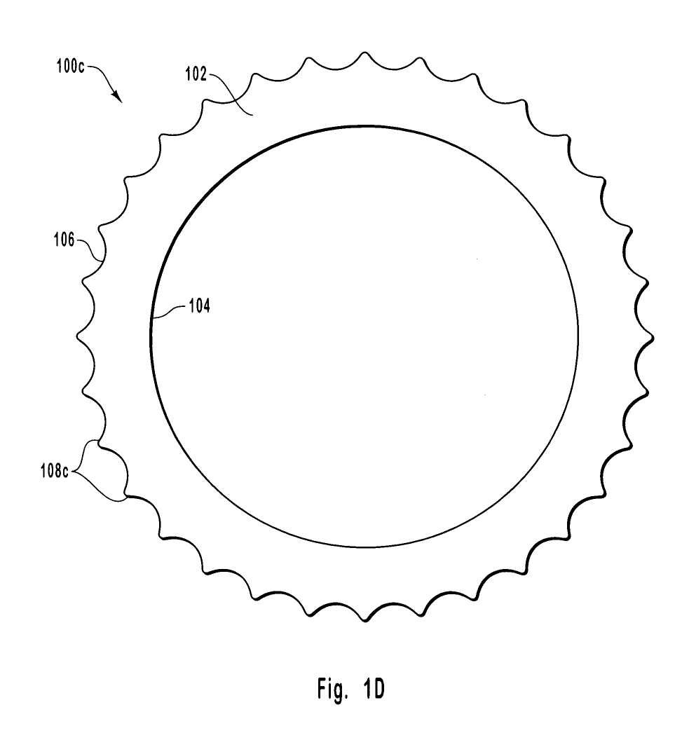

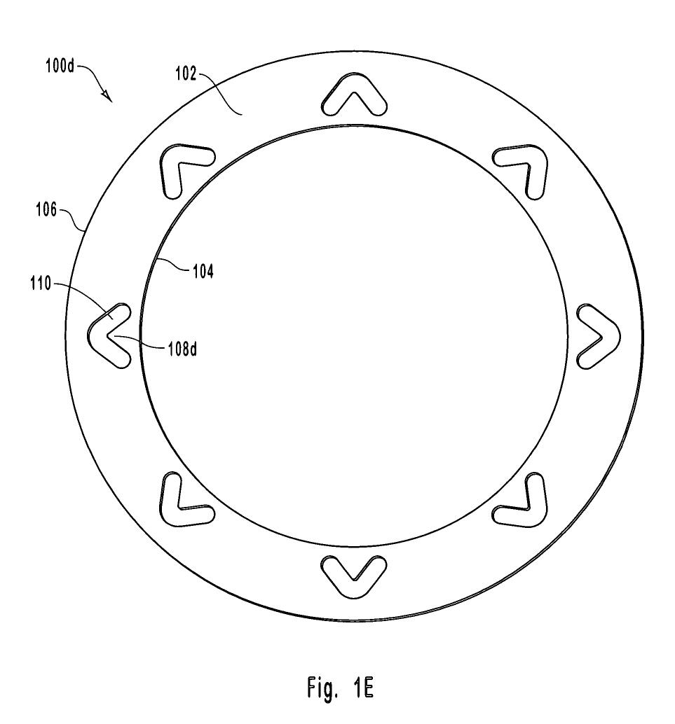

FIGS. 1A-1E illustrate several exemplary rubber dam frames. FIG. 1A illustrates a rubber dam frame 100 having a support member 102 with a circular configuration and including an inner edge 104 and an outer edge 106. Frame 100 also includes a plurality of barbs 108 (e.g., 8 barbs as illustrated). Barbs 108 are formed on the outer edge 106 of the support member 102.

FIGS. 1B-1D illustrate alternative rubber dam frames 100a-100c having a support member 102 with a circular configuration, each having an inner edge 104 and an outer edge 106. Each frame 100a-100c includes a plurality of barbs 108a-108c, each alternative frame having a differing number of barbs 108 (e.g., frame 100a includes 16 barbs as illustrated; frame 100b includes 32 barbs as illustrated; and frame 100c includes 32 barbs as illustrated).

FIG. 1E illustrates an alternative rubber dam frame 100d having a support member 102, an inner edge 104, an outer edge 106, and a plurality of barbs 108d (e.g., 8 barbs as illustrated) formed within recesses 110 of support member 102. The recesses 110 are therefore located between the inner edge 104 and the outer edge 106.

As depicted in FIGS. 1A-1E, the barbs may extend ourwardly and lie substantially on a plane defined by the support member prior to use (assuming it is planar prior to use, which is not required). The barbs may also be oriented laterally relative to a surface of the support member. The barbs are advantageously substantially evenly spaced relative to each other. The support member may include any number of barbs as desired to yield a rubber dam frame having desired functionality. In general, the support member will include at least 3 barbs, preferably at least 6 barbs, more preferably at least 10 barbs.

The support member of the rubber dam frame may be made of a malleable non-resilient metal. One preferred material is aluminum, which may be anodized or otherwise surface treated to enhance its aesthetic appearance. Whether formed of aluminum or another malleable material, the support member preferably has a thickness between about 0.005 and about 0.25 inch, more preferably between about 0.015 and about 0.062 inch, and most preferably between about 0.02 and about 0.04 inch.

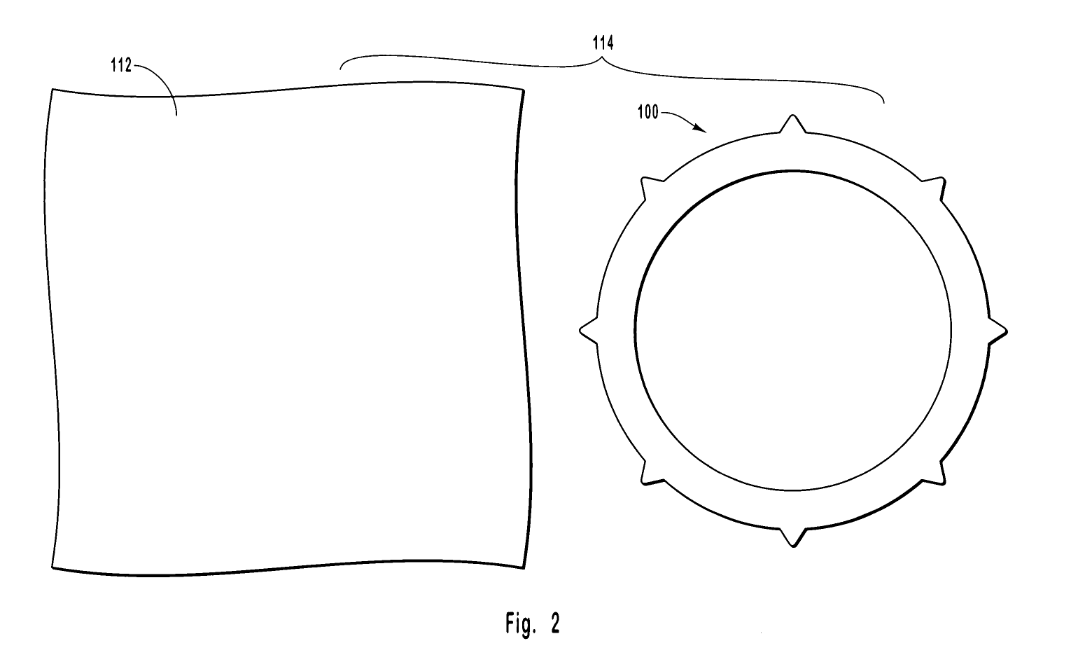

FIG. 2 illustrates a rubber dam frame 100 (e.g., any of those illustrated in FIGS. 1A-1E would be suitable) with a rubber sheet 112. The frame 100 and sheet together comprise a rubber dam kit 114.

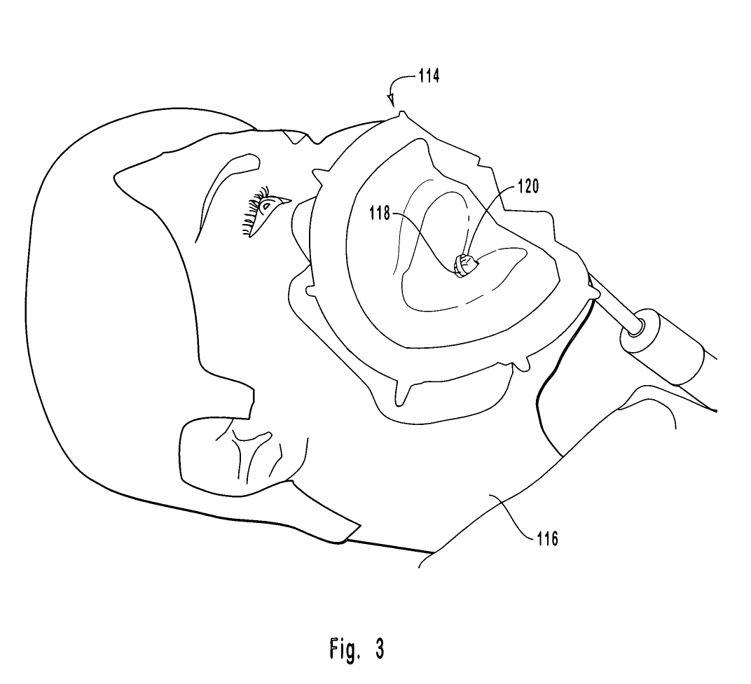

FIG. 3 illustrates the rubber dam kit 114 in place over the mouth of patient 116. One or more clips 118 may be used to hold the rubber dam kit 114 in place, while allowing the exposure of a tooth or teeth 120. As seen, the rubber dam frame covers the patient's mouth except for a small area to be worked on by the dental practitioner. Because the rubber dam kit 114 includes a bendable support member 102, the rubber dam may be bent so as to be more comfortable for the patient. For example, the rubber dam may be bent so as to be more comfortable around the patient's nose, allowing him to breathe more comfortably.

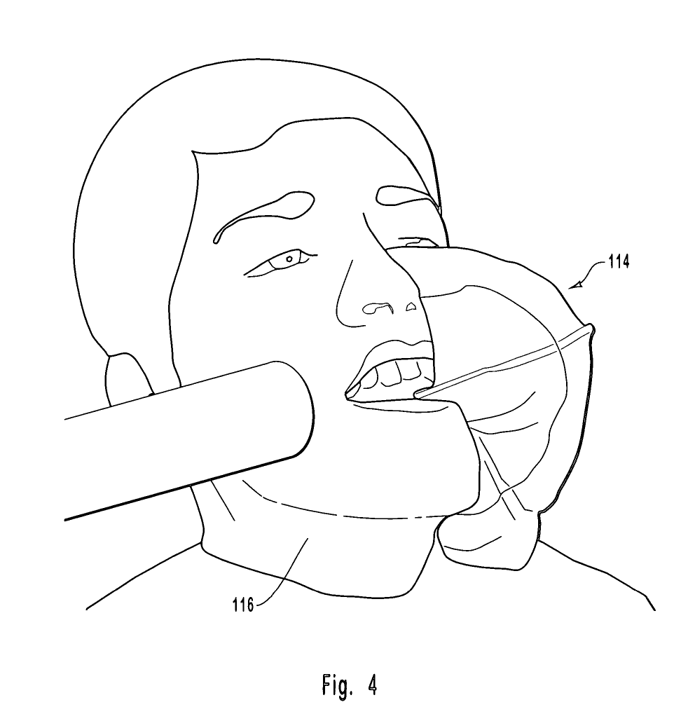

The support member 102 of the rubber dam frame 100 is sufficiently flexible that it may be bent out of the way, when desired. For example, it may aid the dental practitioner in taking x-rays of the patient's teeth and mouth to be able to bend the rubber dam kit 114 out of the way. As shown in FIG. 4, this may be accomplished by simply bending any desired portion of the support member away from the patient's mouth so as to allow unimpeded access to a desired area of the patient's mouth. FIG. 4 illustrates a portion of the rubber dam kit 114 bent away from the patient's mouth, exposing the teeth so as to allow the dental practitioner to more easily take an x-ray.

Once the desired procedure has been performed, the support member of the rubber dam may be bent back to its original position covering the patient's mouth. The rubber dam frame with a bendable support member thus provides additional convenience and ease of use to the dental practitioner while performing various procedures that require access to the patient's mouth because complete removal of the dam is not required.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. A rubber dam frame comprising:
a thin, metal, bendable support member having an inner edge and an outer edge and being sized and configured so as to hold and maintain a rubber dam in a desired orientation relative to a patient's mouth;
wherein the support member is sufficiently bendable so as to allow a dental practitioner to bend a desired portion of the support member away from a patient's mouth during use so as to allow substantially unimpeded access to a desired area of the patient's mouth for performing x-rays or other procedures.

2. A rubber dam frame as recited in claim 1, further comprising barbs for retaining a rubber dam comprising a rubber sheet formed on said support member.

3. A rubber dam frame as recited in claim 2, wherein the barbs are formed on the outer edge of the bendable support member.

4. A rubber dam frame as recited in claim 2, wherein the barbs are formed within recesses within the support member between the inner and outer edges of the support member.

5. A rubber dam frame as recited in claim 2, wherein the rubber damn frame includes at least 3 barbs substantially evenly spaced around the support member.

6. A rubber dam frame as recited in claim 2, wherein the rubber damn frame includes at least 6 barbs substantially evenly spaced around the support member.

7. A rubber dam frame as recited in claim 2, wherein the rubber damn frame includes at least 10 barbs substantially evenly spaced around the support member.

8. A rubber dam frame as recited in claim 2, wherein the barbs extend outwardly and lie substantially in a plane defined by the support member prior to use.

9. A rubber dam frame as recited in claim 2, wherein the barbs extend laterally relative to the support member.

10. A rubber dam frame as recited in claim 1, the support member having a substantially circular configuration.

11. A rubber dam frame as recited in claim 1, wherein the support member comprises aluminum.

12. A rubber dam frame as recited in claim 11, wherein the aluminum comprises anodized aluminum.

13. A rubber dam frame as recited in claim 1, wherein the support member has a thickness in a range of about 0.005 inch to about 0.25 inch.

14. A rubber dam frame as recited in claim 1, wherein the support member has a thickness in a range of about 0.015 inch to about 0.062 inch.

15. A rubber dam frame as recited in claim 1, wherein the support member has a thickness in a range of about 0.02 inch to about 0.04 inch.

16. A rubber dam frame comprising:
a thin, metal, bendable support member having an inner edge and an outer edge; and
barbs on the support member configured so as to hold and maintain a rubber dam in a desired orientation relative to a patient's mouth;
wherein the support member is sufficiently bendable so as to allow a dental practitioner to bend a desired portion of the support member away from a patient's mouth during use so as to allow substantially unimpeded access to a desired area of the patient's mouth for performing x-rays or other procedures.

17. A rubber dam frame as recited in claim 16, wherein the support member comprises aluminum.

18. A rubber dam frame as recited in claim 16, the rubber damn frame comprising at least 6 barbs that are substantially evenly spaced.

19. A rubber dam frame comprising:
a thin, aluminum, bendable support member having an inner edge and an outer edge; and
at least barbs substantially evenly spaced on the support member and configured so as to hold and maintain a rubber dam in a desired orientation relative to a patient's mouth;
wherein the support member is sufficiently bendable so as to allow a dental practitioner to bend a desired portion of the support member away from a patient's mouth during use so as to allow substantially unimpeded access to a desired area of the patient's mouth for performing x-rays or other procedures.

20. A rubber dam kit comprising:
a rubber dam frame as recited in claim 1, and
a rubber dam material.
